(19) United States
(12) Patent Application Publication
(10) Pub. No.: US 2026/0162306 A1
(43) Pub. Date: Jun. 11, 2026

(54) AUTOMATIC LARGE-SCALE CAMERA CALIBRATION

(71) Applicant: NVIDIA Corporation, Santa Clara, CA (US)

(72) Inventors: Naveen Kumar Rai, Gilroy, CA (US); Sean Midthun Pieper, Waldport, OR (US); Qunjie Zhou, Munich (DE); Xunlei Wu, Cary, NC (US); Laura Leal-Taixe, Florence (IT)

(21) Appl. No.: 19/228,952

(22) Filed: Jun. 5, 2025

(30) Foreign Application Priority Data
Dec. 5, 2024 (IT) 102024000027630

(51) Int. Cl. G06T 7/80; G06T 7/00

(52) U.S. Cl. CPC G06T 7/80; G06T 7/97; G06T 2207/20081; G06T 2207/30204; G06T 2207/30241; G06T 2207/30244

(57) ABSTRACT

A pose of the calibration target that is associated with the image is determined determining for each image of the one or more images. The pose includes at least one of a position or an orientation of the calibration target in a local coordinate system of a local positioning system. The image capture device is calibrated based on determining a relationship between the position of the calibration target in the one or more images and the associated local pose of the calibration target in the local coordinate system.

### TECHNICAL FIELD

At least one embodiment pertains to large-scale calibration of cameras according to various novel techniques described herein. For example, embodiments relate to automated calibration of cameras in an industrial environment using a moving calibration target that includes one or more positioning devices that can be tracked using an indoor positioning system according to various novel techniques described herein.

### BACKGROUND

In modern industrial and commercial environments such as factories, warehouses, and retail spaces, there is a growing need for precise object positioning and tracking (e.g., object triangulation). These objects may include people, robots, containers, vehicles, forklifts, or the like. Accurate real-time tracking has numerous applications, from improving safety to enhancing operational efficiency and enabling advanced automation. Many of these environments already have extensive camera networks (e.g., large-scale camera networks) installed, which should theoretically allow for object triangulation using artificial intelligence (AI) powered detectors and trackers. These AI-powered detectors and trackers rely on precise knowledge of each camera's placement, position, and orientation.

During installation of cameras, specifications are utilized by installers to ensure relatively accurate camera positioning on walls or ceilings. However, installers often struggle with achieving exact camera angles, and even minor deviations can result in substantial errors when triangulating object positions across multiple camera views. Existing calibration methods for large-scale camera networks in these environments rely on manual calibration of each camera. Such manual calibration is tedious and time consuming. The sheer scale of these environments, combined with their changing nature, makes manual calibration time-consuming, error-prone, and economically unfeasible.

### BRIEF DESCRIPTION OF DRAWINGS

Various embodiments in accordance with the present disclosure will be described with reference to the drawings, in which:

FIG. 1 illustrates a schematic block diagram of an environment in which large-scale calibration is performed, according to at least one embodiment;

FIG. 2 illustrates a schematic block diagram of a moving calibration target traversing the environment of FIG. 1,, according to at least one embodiment;

FIG. 3 illustrates a moving calibration target of FIG. 2, according to at least one embodiment;

FIG. 4A is a flow diagram of large-scale calibration, according to at least one embodiment;

FIG. 4B is a flow diagram of generating and moving a calibration target, according to at least one embodiment;

FIG. 4C is a flow diagram of aligning an image to a local pose, according to at least one embodiment;

FIG. 5A illustrates hardware structures for inference and/or training logic, according to at least one embodiment;

FIG. 5B illustrates hardware structures for inference and/or training logic, according to at least one embodiment;

FIG. 6 illustrates an example data center system, according to at least one embodiment;

FIG. 7 illustrates a computer system, according to at least one embodiment;

FIG. 8 illustrates a computer system, according to at least one embodiment;

FIG. 9 illustrates at least portions of a graphics processor, according to one or more embodiments;

FIG. 10 illustrates at least portions of a graphics processor, according to one or more embodiments;

FIG. 11 is an example data flow diagram for an advanced computing pipeline, in accordance with at least one embodiment;

FIG. 12 is a system diagram for an example system for training, adapting, instantiating and deploying machine learning models in an advanced computing pipeline, in accordance with at least one embodiment;

FIGS. 13A and 13B illustrate a data flow diagram for a process to train a machine learning model, as well as client-server architecture to enhance annotation tools with pre-trained annotation models, in accordance with at least one embodiment;

FIG. 14 illustrate a block diagram of a computing system, in accordance with at least one embodiment;

FIG. 15 illustrate a block diagram of a computing system, in accordance with at least one embodiment; and

FIG. 16 illustrate a block diagram of a computing system, in accordance with at least one embodiment.

### DETAILED DESCRIPTION

Embodiments described herein relate to systems and methods for large-scale calibration of a camera network (e.g., a large-scale camera network). For example, embodiments enable automated calibration of multiple cameras in an industrial or commercial or residential environment. Such automated calibration may involve moving a calibration target through an environment either manually or using a robot, taking images of the calibration target, determining positioning information of the calibration target using a local positioning system, and using the positioning information and data determined from the images to calibrate each of the cameras. Such a process significantly reduces the amount of time and effort that is expended to calibrate the cameras of the camera network as compared to traditional calibration techniques.

In embodiments, a calibration target in conjunction with a local coordinate system (e.g., of a local positioning system) is used to obtain precise positioning and orientation data of each camera of the large-scale camera network within an environment without introducing substantial complexity or operational disruption. In some embodiments, the calibration target is manually moved through an environment in discrete steps, and calibration of cameras in the environment is automatically performed based on images of the calibration target captured while the calibration target was moved through the environment. Alternatively, the calibration target may be mounted to or otherwise coupled with a robot, which may move the calibration target through the environment. The calibration target includes a visual marker, and one or more positioning devices positioned around the visual marker and/or at known fixed position(s) relative to the visual marker. Each camera of the large-scale camera network that has the calibration target in its field of view captures one or more images of the calibration target one or more times as the calibration target is moved through the environment. A corresponding local pose of the calibration target is repeatedly acquired from the local positioning system as the calibration target moves through the environment. The local pose of the calibration target corresponds to a position and orientation of the calibration target with respect to a reference point associated with the local positioning system.

Within the captured image from a camera of the large-scale camera network, a position of the calibration target (e.g., two-dimensional (2D) position of the calibration target) is determined. Additionally, the corresponding local pose of the calibration target is converted into a global pose by translating a position and orientation of the calibration target with respect to the reference point of the local positioning system to a position and orientation of the calibration target with respect to a reference point of the environment. A camera can then be calibrated using the 2D image coordinates of the calibration target in one or more images and the global pose of the calibration target associated with a captured image from a camera of the large-scale camera network, as determined from the local positioning system. Calibrating the camera involves determining and storing the rotation and translation vectors (forming an extrinsic matrix) that, when applied to 3D world points of the calibration target (predefined 3D points of the calibration target transformed by the global pose), would project these 3D world points onto their corresponding 2D image coordinate in the captured image. The extrinsic matrix, used alongside known intrinsic parameters of the cameras, can accurately relate 3D world points to 2D image coordinates of objects captured in images of calibrated cameras.

In some embodiments, a calibration target is automatically moved through the environment at a predetermined pace. Throughout the traversal of the calibration target in the environment, the large-scale camera network continuously or periodically captures a plurality of images (e.g., plurality of captured images) using cameras for which the calibration target is in a field of view of the cameras. In parallel, an indoor positioning system continuously or periodically captures a pose of the calibration target throughout the traversal of the calibration target in the environment (i.e., a plurality of captured local poses). The plurality of captured images may be reduced to a subset of captured images for a camera, such that each captured image of the subset encompasses the entire calibration target within the camera's field of view. For each captured image of the subset, a pose of the plurality of captured local poses having a timestamp nearest in time to the timestamp of the image may be identified and used to perform calibration of the camera as described above.

In some embodiments, when a captured local pose of the plurality of captured local poses does not have a timestamp within a predefined temporal threshold of the timestamp of a captured image, an interpolated local pose may be determined from at least one captured local pose, and the interpolated local pose may be used for calibration purposes. The at least one interpolated local pose may be derived by performing interpolation between two or more captured local poses of the plurality of captured local poses within a predefined timespan surrounding the timestamp of the respective captured image.

Advantages of the present disclosure include, but are not limited to, providing automated large-scale calibration of cameras in an environment in a manner that is quicker, easier, and/or cheaper than traditional calibration techniques. Additionally, embodiments described herein may be less prone to user error than traditional manual calibration techniques. Additionally, embodiments described herein may be performed using fewer (e.g., no) persons or employees of a company as compared to traditional manual calibration techniques.

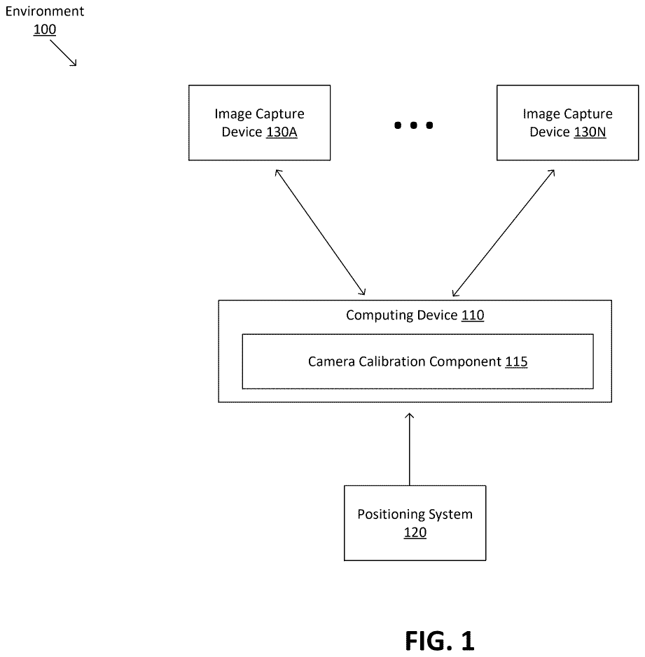

FIG. 1 illustrates a schematic block diagram of an environment 100 in which large-scale calibration is performed in accordance with an embodiment of the present invention. The environment 100 comprises a computing device 110, a local positioning system (positioning system) 120, and one or more image capture devices 130A-130N.

The computing device 110 can be a server computer, a mobile computing device (e.g., a mobile phone, a laptop computer, a tablet computer, etc.), a desktop computer, and so on. The computing device 110 may include one or more processors, one or more memories, one or more storage devices, one or more network controllers (e.g., network interface cards (NICs)), and so on. The processor(s) of the computing device 110 can include, but is not limited to, general-purpose computing equipment (such as central processing units (CPUs), graphics processing units (GPUs), digital signal processors (DSPs), microcontrollers, etc.), specialized computing equipment (including but not limited to field-programmable gate arrays (FPGAs), application-specific integrated circuits (ASICs), tensor processing units (TPUs), neural processing units (NPUs), etc.), or any combination thereof. The computing device 110 may also encompass multi-core processors, distributed processing systems, cloud-based computing resources, quantum computing devices, and any other current or future computing architectures capable of executing instructions and processing data.

The positioning system 120 can comprise, without limitation, wireless communication-based localization devices (including but not limited to Wi-Fi positioning systems, Bluetooth Low Energy (BLE) beacons, ultra-wideband (UWB) sensors, cellular network-based positioning, NFC-based localization, etc.), acoustic-based trackers (such as ultrasonic frequency sensors, sonar-based systems, etc.), advanced optical navigation systems (including but not limited to Light Detection and Ranging (LiDAR)-based Simultaneous Localization and Mapping (SLAM), Visual SLAM (VSLAM), structured light systems, etc.), magnetic field-based positioning systems, inertial navigation systems (INS), global navigation satellite systems (GNSS) including GPS, GLONASS, Galileo, and BeiDou, or any combination of these technologies. The positioning system 120 may also incorporate sensor fusion techniques, using algorithms such as Kalman filters, particle filters, and/or other probabilistic methods to integrate data from multiple positioning technologies for enhanced accuracy and reliability in various indoor and outdoor environments.

The one or more image capture devices 130A-130N may include, but are not limited to, any device or system capable of generating image data, such as images and/or video. These devices may encompass a wide range of imaging technologies, including but not limited to: digital cameras (e.g., complementary metal oxide semiconductor (CMOS) or charge coupled device (CCD) sensor-based cameras), film cameras, multispectral and hyperspectral cameras, thermal imaging cameras, depth cameras or three-dimensional (3D) cameras (e.g., cameras that rely on time-of-flight, structured light, and/or stereo vision systems), 360-degree cameras, high-speed cameras, microscopic imaging devices, telescopic imaging devices, X-ray imaging systems, ultrasound imaging systems, magnetic resonance imaging (MRI) systems, and/or any other current or future technology capable of capturing visual information. The image capture devices 130A-130N may generate various types of image data, including but not limited to: two-dimensional (2D) images, three-dimensional (3D) images, four-dimensional (4D) images (3D+time), color images (in various color spaces such as RGB, CMYK, HSV, etc.), monochrome images, grayscale images, binary images, images captured using specific wavelengths of electromagnetic radiation (e.g., visible light, infrared, near-infrared (NIR), ultraviolet (UV), X-ray, gamma ray, etc.), polarized light images, and/or any other form of visual data representation. The image data may be in various formats, resolutions, and bit depths, and may be either compressed or uncompressed.

In some embodiments, the computing device 110 includes a camera calibration component 115 executed by one or more processors of computing device 110. The camera calibration component 115 may be implemented using the processor(s), and optionally one or more other components. In at least one embodiment, the camera calibration component 115 receives, as a calibration target is manually moved through environment 100 in discrete steps, an image captured by at least one of the one or more image capture devices 130A-130N (e.g., capturing device that has the calibration target in its field of view). The captured image includes the calibration target within the field of view of the capturing device. In embodiments, each discrete step may be a predetermined distance (e.g., 0.5 meters) from a previous position of the calibration target in the environment 100. In some embodiments, the predetermined distance may be varied to improve calibration accuracy. In some embodiments, the calibration target includes a visual marker. The visual marker is a distinctive pattern or symbol designed to be easily recognizable by computer vision systems, such as checkerboard patterns, QR codes, and AprilTag fiducial markers.

The camera calibration component 115, in addition, receives a corresponding local pose of the calibration target from the positioning system 120. The corresponding local pose, as determined by the positioning system 120, represents the position and orientation of the calibration target (at a point in time when the captured image was captured) with respect to a reference point associated with one or more tracking technologies of the positioning system 120. In some embodiments, the calibration target can further include one or more positioning devices detectable by the one or more tracking technologies of the positioning system 120. Each positioning device is a hardware component that emits, reflects, or modulates signals or patterns detectable by tracking technologies in positioning system 120, such as Bluetooth Low Energy (BLE) beacons broadcasting radio signals, retroreflective markers detectable by optical systems, ultra-wideband (UWB) tags transmitting precise timing signals, and RFID tags responding to reader interrogations. The number of positioning devices included in the calibration target may be based on an average distance of the calibration target from tracking technologies and other factors such as required accuracy, environmental conditions, and the calibration target characteristics. In some embodiments, multiple positioning devices are disposed on or attached to the calibration target. For example, two, three, four, or more positioning devices may be attached to the calibration target at a known distance from the calibration target. Accordingly, by determining accurate positions and/or orientations of the one or more positioning devices, an accurate position and orientation of the calibration target may be determined.

In some embodiments, the camera calibration component 115 determines a two-dimensional (2D) position of the calibration target within the captured image as captured by an image capture device 130A-130N. The 2D position of the calibration target within the captured image is determined by identifying coordinates of the calibration target relative to a reference point in the captured image. The 2D position of the calibration target may be measured in pixels in some embodiments, such as pixel coordinates in the x-axis and pixel coordinates in the y-axis at which the calibration target was detected in the image. This process involves extracting a position of the calibration target by detecting the calibration target using image processing and/or machine learning techniques in embodiments. The location of the calibration target may then be expressed as a pair of coordinates (x, y), representing horizontal and vertical distances from a defined origin, usually the top-left corner of the image, to a portion of the calibration target. These coordinates can be measured in pixels, normalized values, or real-world units, depending on the application and image properties.

In some embodiments, the camera calibration component 115 converts the local pose of the calibration target in a positioning system coordinate system to a global pose of the calibration target in a global coordinate system of the environment 100 (e.g., of a factory, a room, a warehouse, etc.). The global pose represents a position and orientation of the calibration target within environment 100, instead of the position and orientation of the calibration target with respect to a reference point associated with one or more tracking technologies of the positioning system 120. The global pose is determined by transforming (or translating) the local pose into a position and an orientation relative to a reference point of the environment 100.

The camera calibration component 115 calibrates the image capture device 130A-130N that captured the image in which the calibration target was detected using the 2D image position and global pose (and/or local pose) of the calibration target. Specifically, the camera calibration component 115 determines the spatial relationship between the image capture device 130A-130N and the calibration target in the environment 100. Since the position and orientation of the calibration target is known to a high degree of accuracy from the positioning system 120 and the position and orientation of the calibration target in the image captured by the image capture device 130A-130N is known to a high degree of accuracy, these two known pieces of information may be used to solve for the unknown variables, which may include the angle of the image capture device and/or the position of the image capture device. In embodiments, the camera calibration component 115 calculates an extrinsic matrix, composed of rotation and translation vectors, which defines the pose of the capturing device relative to a reference point of the environment 100 (used for the global pose). Once such an extrinsic matrix is calculated for a camera, that position and orientation of that camera are known in a global coordinate system, thus causing the camera to be calibrated. By calibrating all of the image capture devices 130A-130N in the environment 100 to the same global coordinate system, movement of objects within the environment 100 can then be tracked accurately as they move between the fields of view of different image capture devices 130A-130N.

In embodiments, camera calibration component 115 determines 3D world points of the calibration target, which may be predefined or computed. When computed, the camera calibration component 115 obtains the known properties of the features (e.g., dimensions, pattern) of the calibration target. Using image processing techniques, the camera calibration component 115 identifies 2D image coordinates of these features in the captured image. Then, using the known properties and the 2D image coordinates, the camera calibration component 115 estimates the 3D positions of the features of the calibration target relative to the capturing device. In some embodiments, geometric algorithms such as perspective-n-point solvers are used for estimation. The estimated 3D positions are then transformed using the reference point of the global pose to obtain their coordinates in the environment 100, thus establishing precise 3D world points of the calibration target.

In embodiments, the calibration component 115 determines how to project 3D world points of the calibration target onto the 2D image plane of the capturing device. The camera calibration component 115 identifies an optimal rotation and translation that, when applied to the 3D world points of the calibration target, align them with corresponding 2D image positions in the captured image. As a result, the camera calibration component 115 produces an extrinsic matrix that accurately describes the global pose of the capturing device, enabling precise mapping between 3D world points and 2D image points. The resulting extrinsic matrix can be stored in the camera itself, if the capturing device supports such functionality, or in other components that process or analyze the captured images.

In some embodiments, the calibration target may be automatically moved (e.g., using an autonomous mobile system (e.g., an automated guided vehicle (AGV), self-driving cart, or robot)) through the environment 100. In embodiments, such movement may be performed at a predetermined pace (e.g., 0.5 meters per second). In some embodiments, the predetermined pace may be varied to improve the calibration accuracy. In some embodiments, the calibration target is automatically moved through the environment 100 along a predefined path. The predefined path may be generated using a virtual replica of the environment 100 within a comprehensive simulation platform in some embodiments. This virtual replica may be analyzed by an occupancy map generator to create a detailed 3D representation of occupied and free areas. Subsequently, a waypoint graph generator may utilize this spatial data to produce a network of interconnected, obstruction-free paths. From this network, a specific traversable path (e.g., the predefined path) may be determined using path planning algorithms that consider factors such as start and end points, visibility by at least one of the one or more image capture device 130A-130N, distance, obstacles, and/or any additional constraints or optimization criteria.

In some embodiments, the calibration target may be automatically moved through the environment 100 (using an autonomous mobile system (e.g., an automated guided vehicle (AGV), self-driving cart, or robot) in real-time by running advanced perception and mapping algorithms (e.g., Light Detection and Ranging (LiDAR) based or Visual Simultaneous Localization and Mapping (VSLAM)) to generate a dynamic representation of the space while simultaneously navigating through environment 100, providing adaptive path planning and obstacle avoidance as the calibration target moves through the environment 100.

The camera calibration component 115 continuously receives, as the calibration target traverses the environment 100, captured images from the one or more image capture devices 130A-130N. Accordingly, once the calibration target has fully traversed the environment 100, the camera calibration component 115 receives a plurality of captured images. Simultaneously, the camera calibration component 115 continuously receives, as the calibration target traverses the environment 100, local poses of the calibration target from the positioning system 120. Accordingly, once the calibration target has fully traversed the environment 100, the camera calibration component 115 receives a plurality of captured local poses.

In some instances, one or more captured images of the plurality of captured images generated by an image capture device 130A-130N may not contain the calibration target within its field of view or may partially contain the calibration target within its field of view. Thus, in some embodiments, the camera calibration component 115 may reduce the plurality of captured images to images which fully contain the calibration target within the camera's field of view by removing those in which the calibration target is not within its field of view or are partially contained within its field of view. For example, for each captured image of the plurality of captured images, the camera calibration component 115 may determine whether a respective captured image includes a complete view of the calibration target. If the respective captured image includes a complete view of the calibration target, the camera calibration component 115 indicates that the respective captured image can be used to identify a corresponding captured local pose. If the respective captured image does not include a complete view of the calibration target, the camera calibration component 115 discards the respective captured image or ignores the frame when identifying a corresponding captured local pose.

In some embodiments, each of the plurality of captured images was captured by one of the one or more image capture devices 130A-130N at a predetermined capture rate (e.g., 30 Hz or 30 fps) or within a predetermined capture range (e.g., 25 Hz to 35 Hz) while each of the plurality of captured local poses was obtained at a capture rate different from the predetermined rate of the plurality of captured images (e.g., 20 Hz or 50 millisecond/data) or within a range (e.g., 15 Hz to 25 Hz). In some embodiments, the plurality of captured images and/or the plurality of captured local poses may be out of order (e.g., inadvertently shuffled). Accordingly, the camera calibration component 115 may sort the plurality of plurality of captured images and/or the plurality of captured local poses in sequential time order by timestamps.

As a result, there may be a mismatch between timestamps of the plurality of captured images and timestamps of the plurality of captured local poses. In other words, images may be captured at slightly different times than when positions of the calibration target were captured. For example, the predetermined capture rate of the plurality of plurality of captured images may be 30 frames per second (fps) equivalent to a frame every 33 ms in some embodiments, and the predetermined capture rate of the plurality of captured local poses may be a frame or measurement every 50 ms/frame in some embodiments. Thus, the plurality of plurality of captured images and the plurality of captured local poses of the above example align every 1650 milliseconds based on the least common multiple (LCM) of the predetermined capture rate of the plurality of plurality of captured images and the predetermined capture rate of the plurality of captured local poses. The alignment of the plurality of plurality of captured images and the plurality of captured local poses every 1650 milliseconds results in 36 alignments every minute (e.g., 60 second/1650 milliseconds).

Accordingly, in some embodiments, the camera calibration component 115 identifies, for each captured image of the plurality of captured images, a captured local pose of the plurality of captured local poses having a timestamp nearest in time to a timestamp of a respective captured image and within a predefined temporal threshold (e.g., 10 milliseconds) of the respective captured image (e.g., a matching captured local pose). The predefined temporal threshold is a time interval on either side of a given timestamp (e.g., timestamp of the respective captured image), creating a window within which a captured local pose that falls within the window is considered relevant or valid for the respective captured image. In some embodiments, the predefined temporal threshold may be determined by balancing between the noise of the plurality of captured local poses due to the continuous movement of the calibration target and a number of captured frames necessary for calibration.

The camera calibration component 115 may determine a two-dimensional (2D) position of the calibration target within the respective captured image. Additionally, the camera calibration component 115 may convert the matching local pose to a global pose of the calibration target. The camera calibration component 115 calibrates, using the 2D image position and global pose of the calibration target, an image capture device of the plurality of image capture devices that captured the respective captured image. While the image may have been captured at a slightly different time than the position of the calibration target was determined, the difference in times between the two may be small enough that such differences are immaterial to the calibration process.

In some instances, there are no captured local poses in the plurality of captured local poses that are within the predefined temporal threshold of the respective captured image. In such instances, the camera calibration component 115 may compute one or more interpolated local poses that represents where the calibration target would have been at one or more specific times, if those moments had been captured. Depending on the embodiment, the one or more interpolated local poses may be computed by performing interpolation between two or more captured local poses of the plurality of captured local poses within a predefined timespan surrounding the timestamp of the respective captured image. Performing interpolation may include estimating intermediate values between known data points to create a continuous representation of data or motion. The predefined timespan is a window within which one or more captured local poses that fall within the window can be considered for interpolation. In some embodiments, the camera calibration component 115 selects, from the one or more interpolated local poses, an interpolated local pose having a timestamp nearest in time to a timestamp of a respective captured image (e.g., selected interpolated local pose).

In some embodiments, the camera calibration component 115 determines a two-dimensional (2D) position of the calibration target within the respective captured image. Additionally, the camera calibration component 115 may convert the selected interpolated local pose to a global pose of the calibration target. The camera calibration component 115 may calibrate, using the 2D image position and global pose of the calibration target, an image capture device of the plurality of image capture devices that captured the respective captured image.

In some embodiments, multiple images and associated poses of the calibration target as determined using positioning system 120 are used to calibrate a single image capture device 130A-130N. For example, calibration values (e.g., extrinsic matrices) may be computed for each image of the calibration target by a camera. The calibration values may then be averaged to determine a final calibration value (e.g., a final extrinsic matrix). In some embodiments, weights may be applied to one or more images based on properties that affect accuracy and/or confidence, such as distance between the image capture device 130A-130N and the calibration target, angle of calibration target relative to the image capture device 130A-130N, sharpness or blurriness of the image, and so on. For example, images for which the calibration target was closer to the camera (and thus appear larger in the image) may be assigned a higher confidence value than images for which the calibration target was further from the camera. Similarly, images with a higher blurriness may be assigned a lower confidence rating. In some embodiments, a weighted average of the multiple calibration values may be determined using the applied weights.

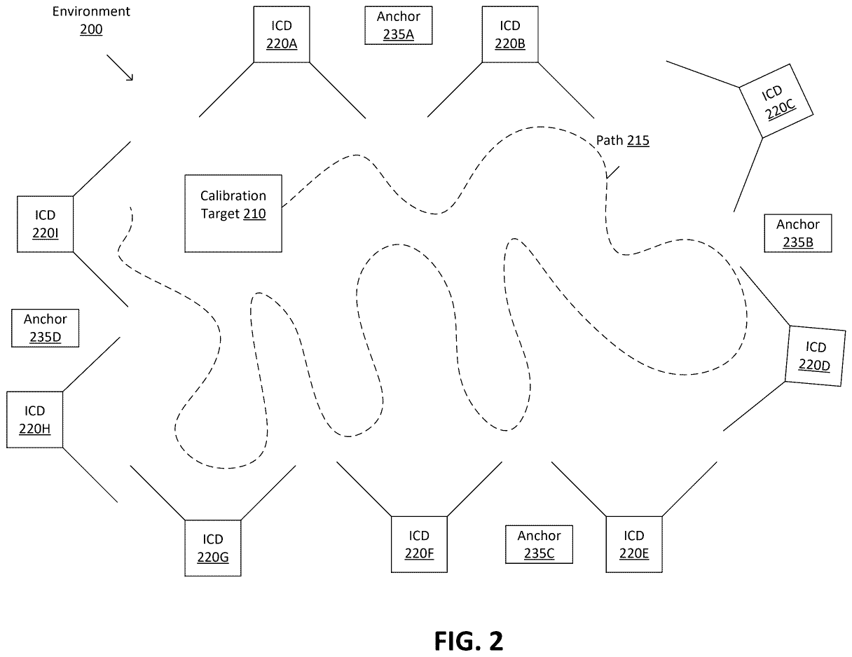

FIG. 2 illustrates a schematic block diagram of a moving calibration target traversing the environment of FIG. 1 in accordance with an embodiment of the present invention. Environment 200, similar to environment 100 of FIG. 1, may be a factory, warehouse, retail space, etc. The environment 200 may include a plurality of image capture devices (e.g., ICD 220A-220I). Each of the plurality of image capture devices may be positioned at various locations within the environment 200. In some embodiments, as previously described, a camera calibration component (e.g., camera calibration component 115 of FIG. 1) may generate a path 215 for a calibration target 210 to be moved throughout the environment 200. The path may be generated such that the calibration target 210 is visible by the plurality of image capture devices and in proximity to a plurality of anchors (e.g., anchor 235A-235D) of a local positioning system (e.g., positioning system 120 of FIG. 1) to allow for reliable measurement of the position of the calibration target 210. Each of the plurality of anchors of the local positioning system refers to a fixed reference point with a known location used to determine the position of the calibration target 210 relative to it. In some embodiments, each of the plurality of anchors may be GPS satellite, Wi-Fi router, Bluetooth beacon, or any suitable device that emits a signal. In some embodiments, a single anchor 235A may be used.

As previously described, as the calibration target 210 moves along path 215, ICD 220A-220I captures images of the calibration target 210 and anchor 235A-235D captures local poses of the calibration target 210. The camera calibration component receives a plurality of captured images (e.g., the images captured by ICD 220A-220I) and a plurality of local poses (e.g., the local poses captured by anchor 235A-235D). The camera calibration component may reduce the plurality of captured images to those fully containing the calibration target within a capturing ICD's field of view. The camera calibration component selects, for each captured image of the plurality of captured images, a corresponding local pose. The local pose may be a position and/or orientation of the calibration target relative to a local coordinate system and/or a global coordinate system. In some embodiments, the corresponding local pose may be a local pose of the plurality of local poses with a timestamp matching a timestamp of a respective captured image. For example, calibration target may be moved to a designated position, and a command may be given to both capture an image of the calibration target 210 by one or more ICDs 220A-220I and to measure a position/orientation (e.g., pose) of the calibration target 210 using the local positioning system. In such an embodiment, the image and pose may be captured at the same time, and thus may have a same timestamp. In some embodiments, the corresponding local pose may be a local pose of the plurality of local poses with a timestamp nearest in time to the timestamp of the respective captured image and within the predefined temporal threshold. For example, the local positioning system may continuously or periodically capture poses of the calibration target at a first frame rate and the ICDs 220A-220I may continuously capture images of the calibration target 210 at a second frame rate. Accordingly, timestamps of images and poses may not perfectly align. In some embodiments, the corresponding local pose may be an interpolated local pose generated using one or more local poses of the plurality of local poses within a predefined timespan surrounding the timestamp of the respective captured image.

The camera calibration component determines a two-dimensional (2D) position of the calibration target within the respective captured image(s) of each ICD 220A-220I. Additionally, the camera calibration component 115 converts the corresponding local pose(s) of the calibration target 210 to global pose(s) of the calibration target. The camera calibration component 115 calibrates, using the 2D image position(s) and global pose(s) (and/or local pose(s)) of the calibration target, one or more image capture devices 220A-220I of the plurality of image capture devices that captured the respective captured image(s).

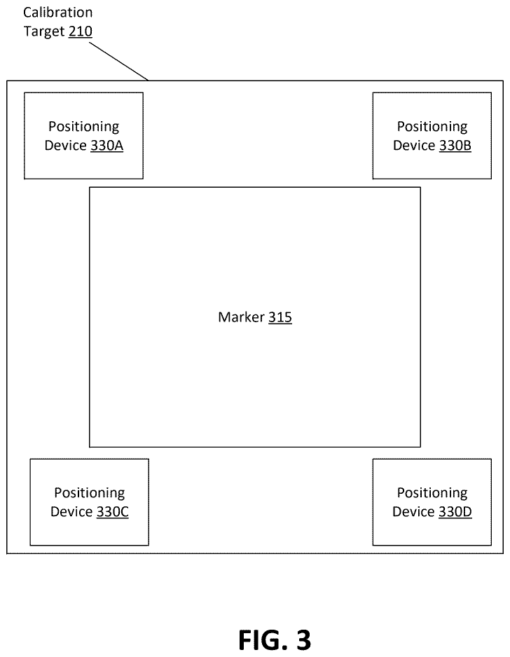

FIG. 3 illustrates an example calibration target in accordance with an embodiment of the present invention. The calibration target 210 includes a marker 315 and one or more positioning devices 330A-330D. The marker 315, as previously described, may be a distinctive pattern or symbol designed to be easily recognizable by computer vision systems, such as checkerboard patterns, QR codes, and AprilTag fiducial markers. In some embodiments, the marker includes one or more spheres and/or other geometric shapes, one or more colors, and so on. The one or more positioning devices 330A-330D, as previously described, may be a hardware component that emits, reflects, or modulates detectable signals or patterns, such as Bluetooth Low Energy (BLE) beacons broadcasting radio signals, retroreflective markers detectable by optical systems, ultra-wideband (UWB) tags transmitting precise timing signals, and RFID tags responding to reader interrogations. In some embodiments, each of the one or more positioning devices 330A-330D may be positioned along an outer perimeter of the calibration target 210. More specifically, positioning devices 330A-330C may be positioned at each corner or positioned along the outer perimeter of the calibration target in some embodiments. In some embodiments, the calibration target 210 may include two of the one or more positioning devices 330A-330D positioned diagonally from one another. In some embodiments, in which both position and orientation can be determined from a single positioning device, a single positioning device is disposed on calibration target 210.

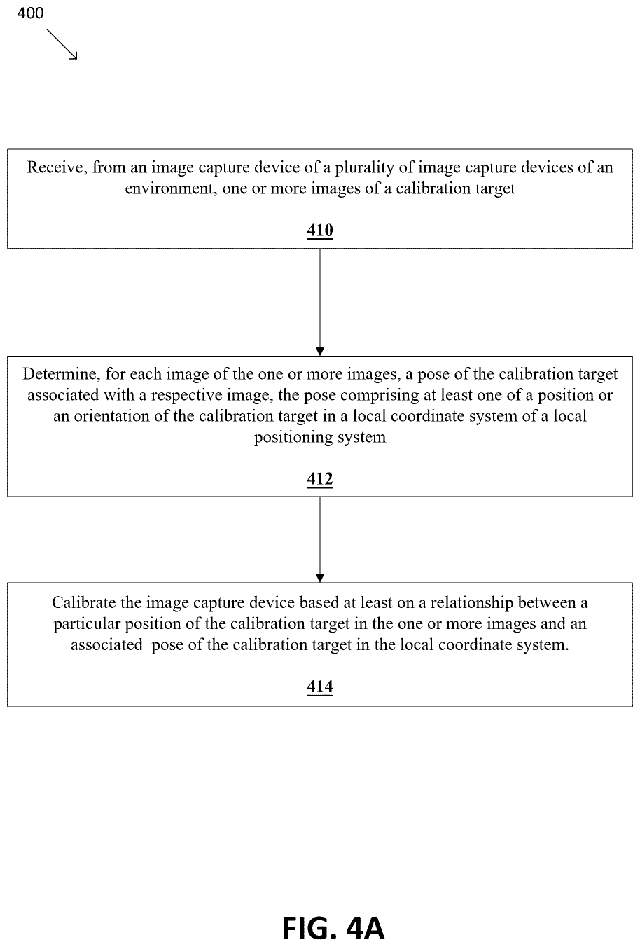

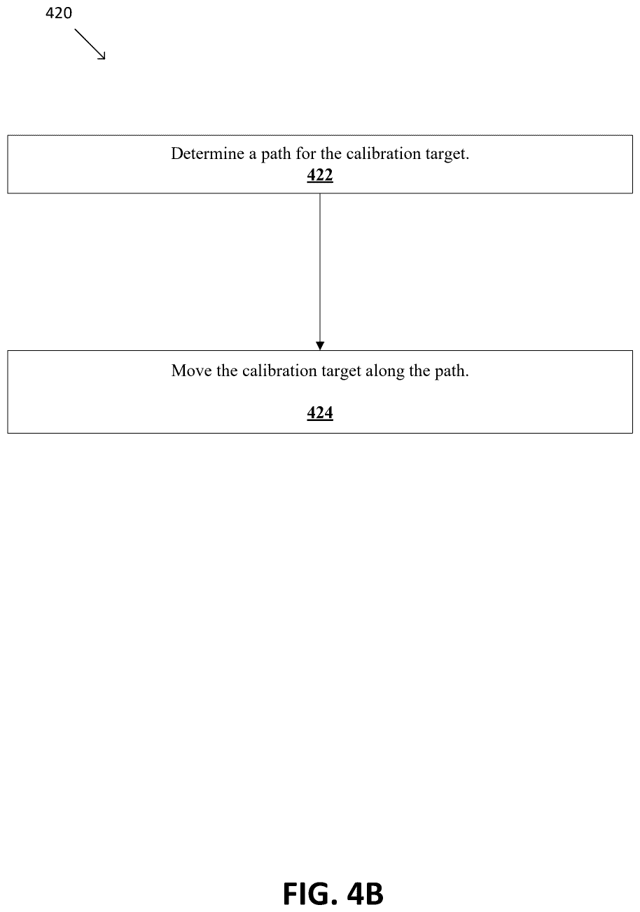

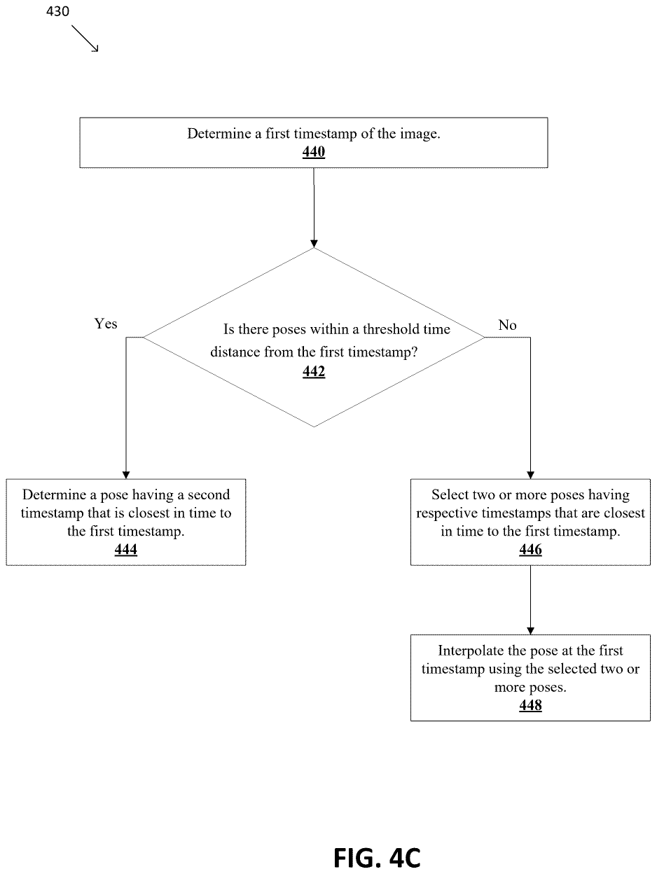

FIG. 4A depicts a flow diagram of an example method 400 for large-scale camera calibration, in accordance with one or more aspects of the present disclosure. The method may be performed by processing logic that may comprise hardware (circuitry, dedicated logic, etc.), computer readable instructions (run on a general purpose computer system or a dedicated machine), or a combination of both. In an illustrative example, method 400 may be performed by a processor, such as processor 110 in FIG. 1. Alternatively, some or all of method 400 might be performed by another module or machine. It should be noted that blocks depicted in FIG. 4A could be performed simultaneously or in a different order than that depicted.

At block 410, the processing logic captures, using an image capture device of a plurality of image capture devices of an environment, one or more images of a calibration target. In some embodiments, the calibration target may include a visual marker detectable by the plurality of image capture devices and one or more positioning devices positioned around the visual marker that are detectable by the local positioning system. For example, the one or more positioning devices may be detectable by one or more anchors of the local positioning system.

At block 412, the processing logic determines, for each image of the one or more images, a pose of the calibration target that may be associated with the image. The pose may include at least one of a position or an orientation of the calibration target in a local coordinate system of a local positioning system.

In some embodiments, the image capture device may capture images at a first frame rate while the local positioning system may capture poses of the calibration target at a second frame rate that may be different from the first frame rate. Thus, the processing logic determines for an image the pose of the calibration target that may be associated with the image. In particular, the processing logic determines a first timestamp of the image and a pose from a plurality of poses of the calibration target having a second timestamp that may be closest in time to the first timestamp.

Alternatively, the processing logic determines that no poses have a second timestamp that may be within a threshold time distance from the first timestamp. So, the processing logic selects two or more poses from the plurality of poses that have respective timestamps that are closest in time to the first timestamp and interpolates the pose at the first timestamp using the selected two or more poses. As previously described, the two or more poses that are selected are within a predefined timespan surrounding the timestamp of the respective captured image. Interpolation refers to estimating intermediate values between known data points to create a continuous representation of data or motion. The predefined timespan may be a window within which one or more captured local pose that falls within the window can be considered for interpolation.

At block 414, the processing logic calibrates the image capture device based on determining a relationship between a particular position of the calibration target in the one or more images and an associated local pose of the calibration target in the local coordinate system. More specifically, in some embodiments, the processing logic determines the relationship between the particular position of the calibration target in an image of the one or more images and the associated pose of the calibration target by determining the particular position of the calibration target in the image (e.g., 2D position), determining the position and orientation of the calibration target of the pose associated with the image, and calculating rotation and translation vectors that form an extrinsic calibration matrix for the image capture device.

In some embodiments, the pose may be converted to a global pose of the calibration target in a global coordinate system of the environment based on at least one of an offset or a rotation between the local coordinate system and the global coordinate system.

Depending on the embodiment, the processing logic determines a path for the calibration target that travels through fields of view of the plurality of image capture devices and moves the calibration target along the path. Each of the plurality of image capture devices may be calibrated based on images of the calibration target and associated poses of the calibration target generated as the calibration target moves along the path. The calibration target may be attached to a robot that automatically moves the calibration target along the path.

Once the image capture devices of an environment (e.g., environment 100 of FIG. 1 and/or environment 200 of FIG. 2) are calibrated, the images from the image capture devices may be used for inference and/or training of one or more machine learning models, such as deep neural networks. For example, images from the cameras may be used to perform object detection, object tracking, and so on.

FIG. 4B depicts a flow diagram of an example method 420 for generating and moving a calibration target, in accordance with one or more aspects of the present disclosure. The method may be performed by processing logic that may comprise hardware (circuitry, dedicated logic, etc.), computer readable instructions (run on a general purpose computer system or a dedicated machine), or a combination of both. In an illustrative example, method 400 may be performed by a processor, such as processor 110 in FIG. 1. Alternatively, some or all of method 400 might be performed by another module or machine. It should be noted that blocks depicted in FIG. 4B could be performed simultaneously or in a different order than that depicted.

At block 422, the processing logic determines a path within an environment for the calibration target. The path may allow the calibration target to travel through fields of view of a plurality of image capture devices. As previously described, the path may be determined by generating a virtual replica of an environment, creating a 3D representation of occupied and free areas of the environment, and producing a network of interconnected, obstruction-free paths. The processing logic determines, using network of interconnected, obstruction-free paths, a specific traversable path. In some embodiments, the path may be determined using, for example, a simulation environment (e.g., NVIDIA's DriveSIM) using simulated data (e.g., simulated sensor data of simulated sensors of a virtual or simulated machine). In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

At block 424, the processing logic moves the calibration target along the path. As previously described, the calibration target may be automatically and adaptively moved along the path using an autonomous mobile system equipped with mapping algorithms to simultaneously generate a dynamic representation of the space.

FIG. 4C depicts a flow diagram of an example method 430 for aligning an image to a local pose, in accordance with one or more aspects of the present disclosure. The method may be performed by processing logic that may comprise hardware (circuitry, dedicated logic, etc.), computer readable instructions (run on a general purpose computer system or a dedicated machine), or a combination of both. In an illustrative example, method 400 may be performed by a processor, such as processor 110 in FIG. 1. Alternatively, some or all of method 400 might be performed by another module or machine. It should be noted that blocks depicted in FIG. 4C could be performed simultaneously or in a different order than that depicted. In some embodiments, method 430 is performed at block 412 of FIG. 4A.

At block 440, the processing logic determines a first timestamp of an image.

At block 442, the processing logic determines whether there are poses within a threshold time distance from the first timestamp. As previously described, the threshold time distance (or predefined temporal threshold) may be a time interval on either side of the first timestamp, creating a window within which a pose that falls within the window is considered relevant or valid for the image. If there are any poses having a timestamp that is within a threshold time distance from the timestamp of the image, the method proceeds to block 444. Otherwise, the method may proceed to block 446.

At block 444, responsive to determining that there are one or more poses that have timestamps within the threshold time distance from the first timestamp, the processing logic determines a pose having a second timestamp that is closest in time to the first timestamp.

At block 446, responsive to determining that there are no poses within the threshold time distance from the first timestamp, the processing logic may select two or more poses that have respective timestamps that are closest in time to the first timestamp and that include at least one pose with a timestamp earlier than the timestamp of the image and at least one pose with a timestamp later than the timestamp of the image. At block 448, responsive to selecting two or more poses that have respective timestamps that are closest in time to the first timestamp, the processing logic interpolates the pose at the first timestamp using the selected two or more poses. As previously described, the processing logic estimates one or more interpolated local poses between the selected two or more poses to create a continuous representation of data or motion. The processing logic further selects an interpolated local pose having a timestamp nearest in time to the first timestamp is selected. In some cases, if no poses have timestamps that are within a threshold time distance from a timestamp of an image, that image is discarded or filtered out and thus not used for calibration purposes.

In some embodiments, the systems and methods described herein may be performed together with a simulation environment (e.g., NVIDIA's DriveSIM) using simulated data (e.g., simulated sensor data of simulated sensors of a virtual or simulated machine), such as to determine a path for a calibration target to follow for capture of images of the calibration target. These simulated operations may be used to test performance of the underlying algorithms, systems, and/or processes prior to deploying them in the real-world. In some instances, the simulation may be used to generate synthetic training data—e.g., training data including regions of interest and/or sub-regions of interest from within the simulation. The synthetic training data (in addition to or alternatively from real-world data) may then be processed to determine geometry and/or other information related to regions of interest, such as pallet delivery locations within a warehouse, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

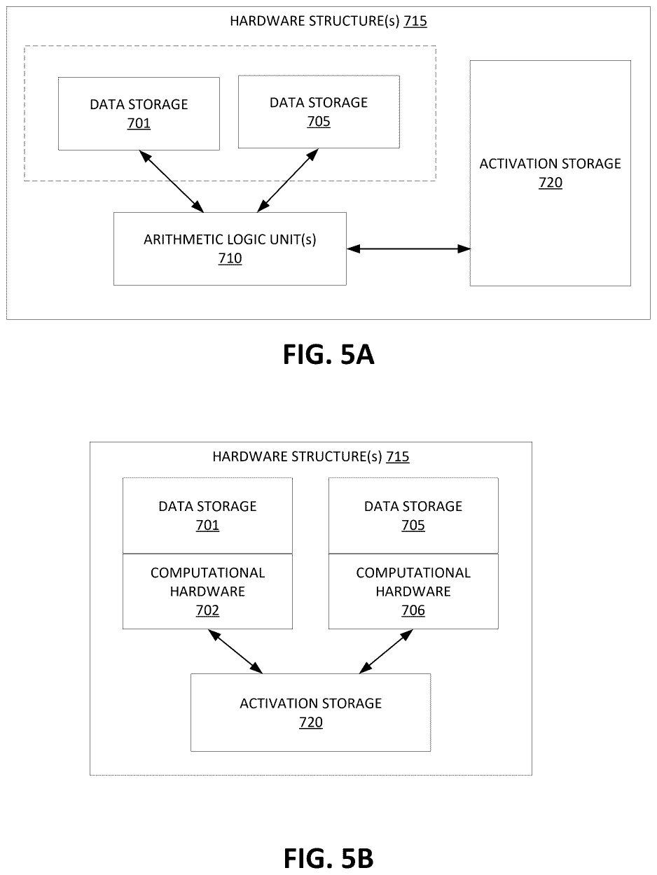

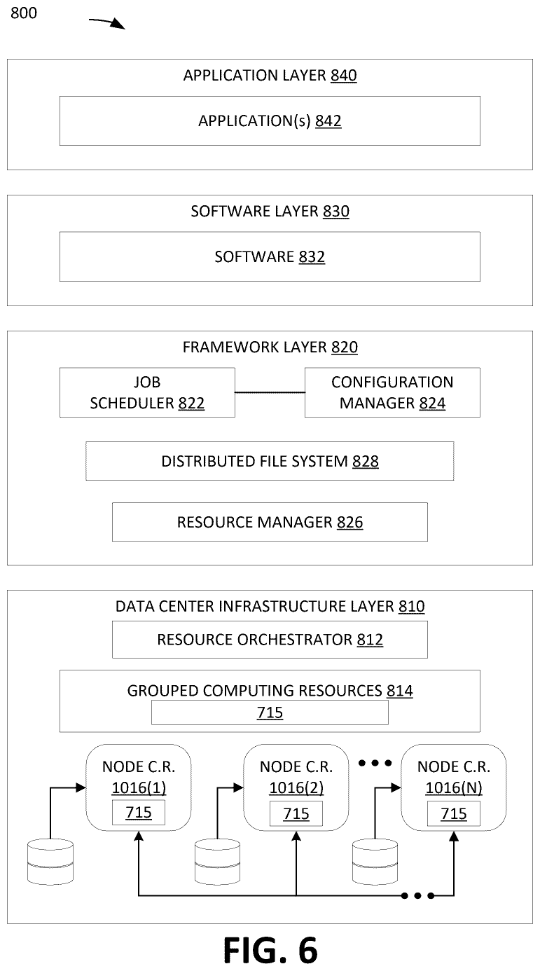

FIG. 5A illustrates hardware structures 715 that may be used in one or more embodiments.

In at least one embodiment, hardware structures 715 for inference and/or training logic may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, hardware structures 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, hardware structures 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, hardware structures 715 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, hardware structures 715 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates hardware structures 715, according to at least one or more embodiments. In at least one embodiment, hardware structures 715 may include, without limitation, hardware logic in which computational resources are dedicated or otherwise exclusively used in conjunction with weight values or other information corresponding to one or more layers of neurons within a neural network. In at least one embodiment, hardware structures 715 illustrated in FIG. 5B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, hardware structures 715 illustrated in FIG. 5B may be used in conjunction with central processing unit (CPU) hardware, graphics processing unit (GPU) hardware or other hardware, such as field programmable gate arrays (FPGAs). In at least one embodiment, hardware structures 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 5B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in hardware structures 715.

### DATA CENTER

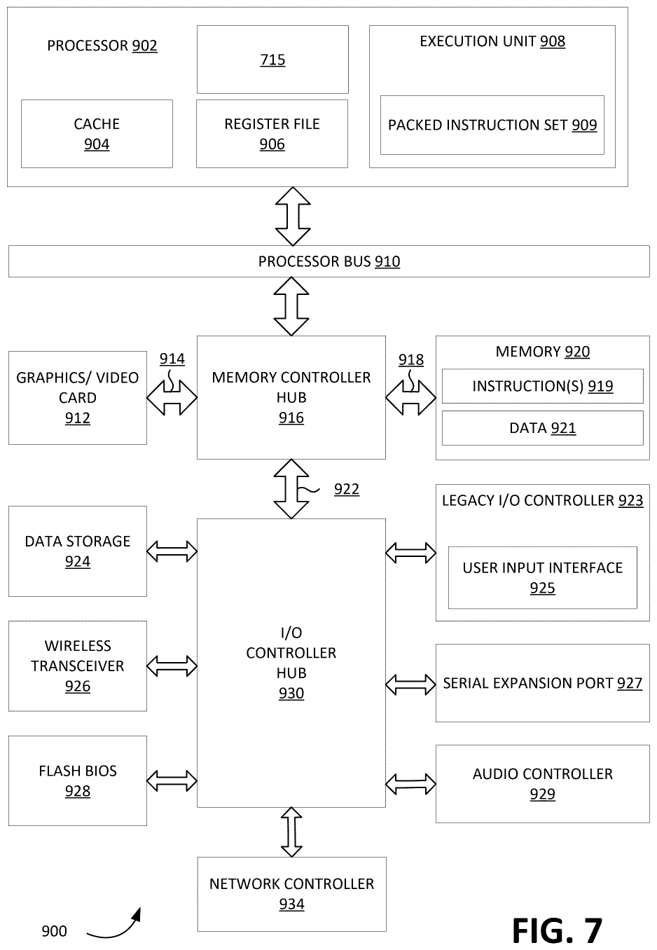

FIG. 6 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 6, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator may include hardware, software or some combination thereof.

In at least one embodiment, as shown in FIG. 6, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Hardware structures 715 are used to perform inferencing and/or training operations associated with one or more embodiments. Details regarding hardware structures 715 are provided herein in conjunction with FIGS. 5A and/or 5B. In at least one embodiment, inference and/or training logic may be used in system FIG. 6 for inferencing or predicting operations based, at least in part, on weight parameters calculated using neural network training operations, neural network functions and/or architectures, or neural network use cases described herein.

Such components can be used to generate synthetic data imitating failure cases in a network training process, which can help to improve performance of the network while limiting the amount of synthetic data to avoid overfitting.

### COMPUTER SYSTEMS

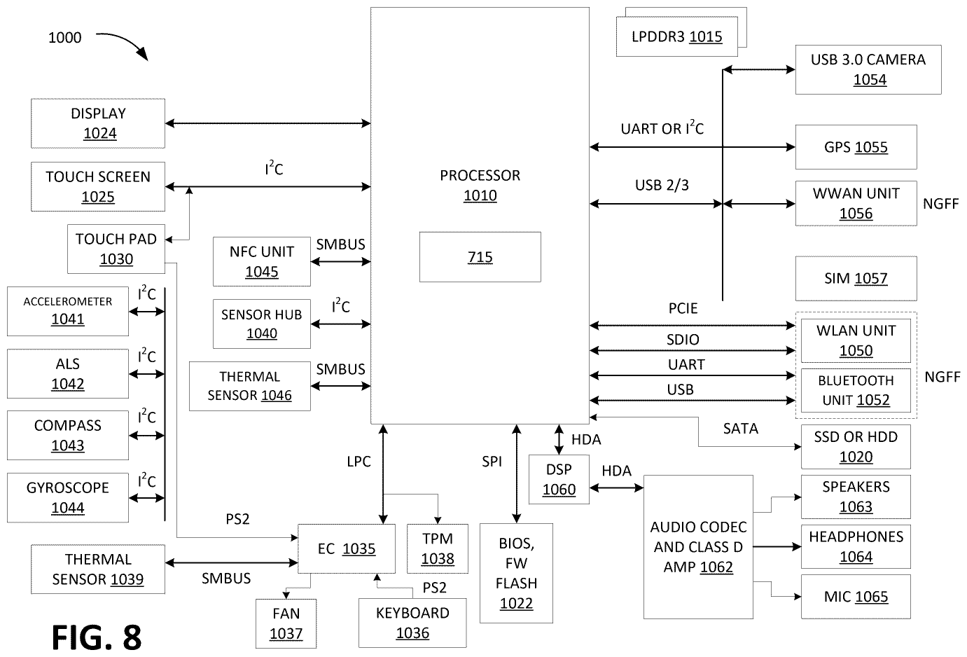

FIG. 7 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 7 illustrates a system, which includes interconnected hardware devices or “chips,” whereas in other embodiments, FIG. 7 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Hardware structures 715 are used to perform inferencing and/or training operations associated with one or more embodiments. Details regarding inference and/or training logic are provided herein in conjunction with FIGS. 5A and/or 5B. In at least one embodiment, inference and/or training logic may be used in system FIG. 7 for inferencing or predicting operations based, at least in part, on weight parameters calculated using neural network training operations, neural network functions and/or architectures, or neural network use cases described herein.

Such components can be used to generate synthetic data imitating failure cases in a network training process, which can help to improve performance of the network while limiting the amount of synthetic data to avoid overfitting.

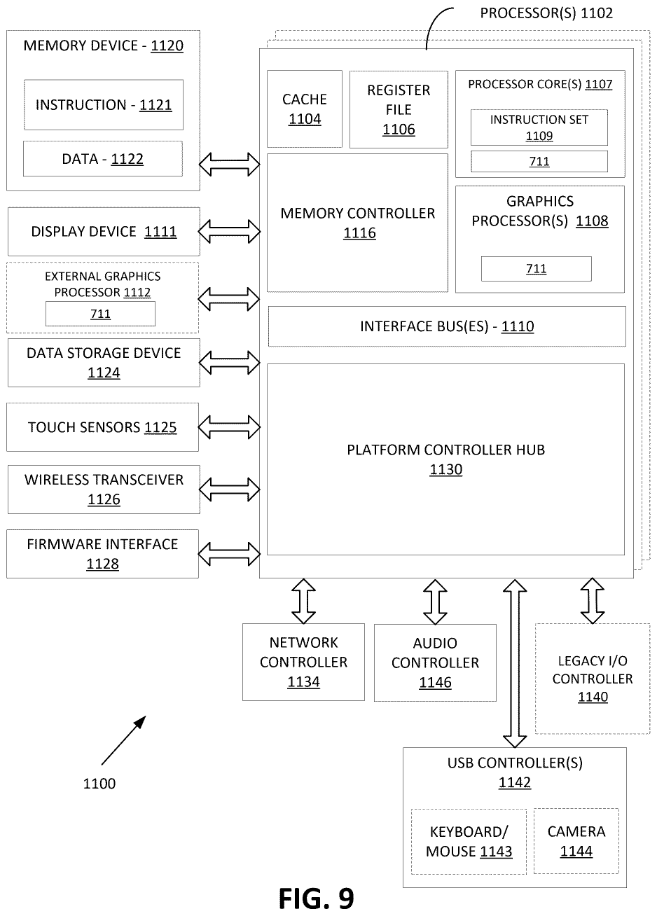

FIG. 8 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, system 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 8 illustrates a system, which includes interconnected hardware devices or “chips,” whereas in other embodiments, FIG. 8 may illustrate an exemplary System on a Chip (“SoC”). In at least one embodiment, devices illustrated in FIG. 8 may be interconnected with proprietary interconnects, standardized interconnects (e.g., PCIe) or some combination thereof. In at least one embodiment, one or more components of FIG. 8 are interconnected using compute express link (CXL) interconnects.

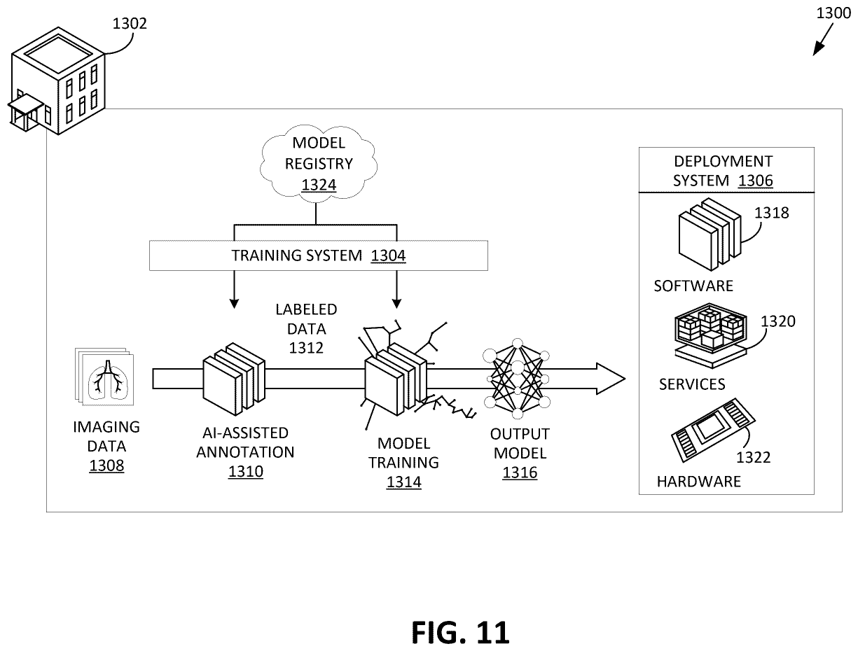

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1046, and a touch pad 1030 may be communicatively coupled to EC 1035. In at least one embodiment, speaker 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1064 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic are used to perform inferencing and/or training operations associated with one or more embodiments. Details regarding inference and/or training logic are provided herein conjunction with FIGS. 5A and/or 5B. In at least one embodiment, inference and/or training logic may be used in system FIG. 8 for inferencing or predicting operations based, at least in part, on weight parameters calculated using neural network training operations, neural network functions and/or architectures, or neural network use cases described herein.

Such components can be used to generate synthetic data imitating failure cases in a network training process, which can help to improve performance of the network while limiting the amount of synthetic data to avoid overfitting.

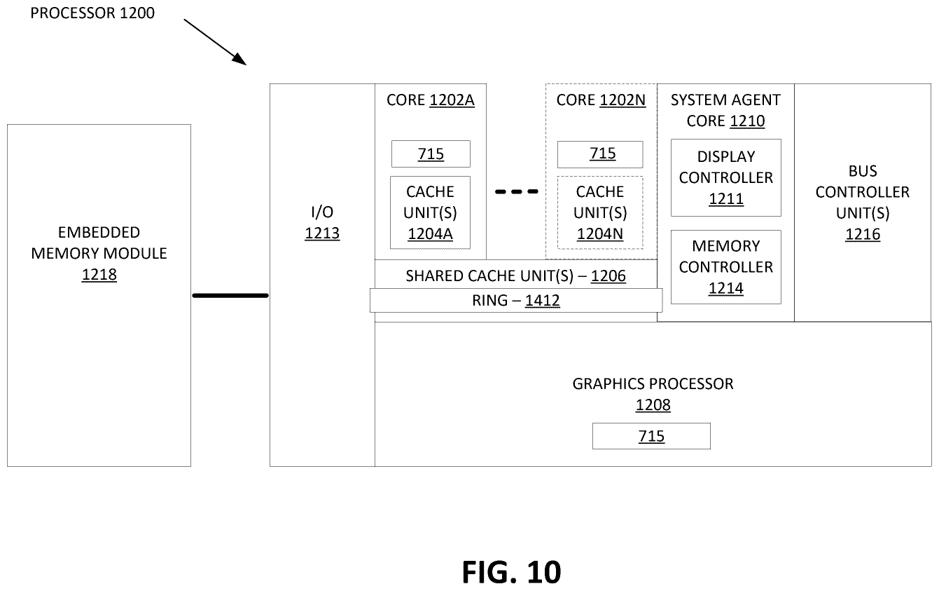

FIG. 9 is a block diagram of a processing system, according to at least one embodiment. In at least one embodiment, system 1100 includes one or more processors 1102 and one or more graphics processors 1108, and may be a single processor desktop system, a multiprocessor workstation system, or a server system having a large number of processors 1102 or processor cores 1107. In at least one embodiment, system 1100 is a processing platform incorporated within a system-on-a-chip (SoC) integrated circuit for use in mobile, handheld, or embedded devices.

In at least one embodiment, system 1100 can include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, processing system 1100 can also include, couple with, or be integrated within a wearable device, such as a smart watch wearable device, smart eyewear device, augmented reality device, or virtual reality device. In at least one embodiment, processing system 1100 is a television or set top box device having one or more processors 1102 and a graphical interface generated by one or more graphics processors 1108.

In at least one embodiment, one or more processors 1102 each include one or more processor cores 1107 to process instructions which, when executed, perform operations for system and user software. In at least one embodiment, each of one or more processor cores 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor cores 1107 may each process a different instruction set 1109, which may include instructions to facilitate emulation of other instruction sets. In at least one embodiment, processor core 1107 may also include other processing devices, such a Digital Signal Processor (DSP).

In at least one embodiment, processor 1102 includes cache memory 1104. In at least one embodiment, processor 1102 can have a single internal cache or multiple levels of internal cache. In at least one embodiment, cache memory is shared among various components of processor 1102. In at least one embodiment, processor 1102 also uses an external cache (e.g., a Level-3 (L3) cache or Last Level Cache (LLC)) (not shown), which may be shared among processor cores 1107 using known cache coherency techniques. In at least one embodiment, register file 1106 is additionally included in processor 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor 1102 and other components in system 1100. In at least one embodiment, interface bus 1110, in one embodiment, can be a processor bus, such as a version of a Direct Media Interface (DMI) bus. In at least one embodiment, interface 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for system 1100, to store data 1122 and instructions 1121 for use when one or more processors 1102 executes an application or process. In at least one embodiment, memory controller 1116 also couples with an optional external graphics processor 1112, which may communicate with one or more graphics processors 1108 in processors 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and can be, for example, a unified extensible firmware interface (UEFI). In at least one embodiment, network controller 1134 can enable a network connection to a wired network. In at least one embodiment, a high-performance network controller (not shown) couples with interface bus 1110. In at least one embodiment, audio controller 1146 is a multi-channel high definition audio controller. In at least one embodiment, system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controllers 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, system 1100 can include an external memory controller 1116 and platform controller hub 1130, which may be configured as a memory controller hub and peripheral controller hub within a system chipset that is in communication with processor(s) 1102.

Inference and/or training logic are used to perform inferencing and/or training operations associated with one or more embodiments. Details regarding inference and/or training logic are provided herein in conjunction with FIGS. 5A and/or 5B. In at least one embodiment portions or all of inference and/or training logic may be incorporated into graphics processor 1500. For example, in at least one embodiment, training and/or inferencing techniques described herein may use one or more of ALUs embodied in a graphics processor. Moreover, in at least one embodiment, inferencing and/or training operations described herein may be done using logic other than logic described with respect to FIG. 5A or 5B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used to generate synthetic data imitating failure cases in a network training process, which can help to improve performance of the network while limiting the amount of synthetic data to avoid overfitting.

FIG. 10 is a block diagram of a processor 1200 having one or more processor cores 1202A-1202N, an integrated memory controller 1214, and an integrated graphics processor 1208, according to at least one embodiment. In at least one embodiment, processor 1200 can include additional cores up to and including additional core 1202N represented by dashed lined boxes. In at least one embodiment, each of processor cores 1202A-1202N includes one or more internal cache units 1204A-1204N. In at least one embodiment, each processor core also has access to one or more shared cached units 1206.

In at least one embodiment, internal cache units 1204A-1204N and shared cache units 1206 represent a cache memory hierarchy within processor 1200. In at least one embodiment, cache memory units 1204A-1204N may include at least one level of instruction and data cache within each processor core and one or more levels of shared mid-level cache, such as a Level 2 (L2), Level 3(L3 ), Level 4(L4 ), or other levels of cache, where a highest level of cache before external memory is classified as an LLC. In at least one embodiment, cache coherency logic maintains coherency between various cache units 1206 and 1204A-1204N.

In at least one embodiment, processor 1200 may also include a set of one or more bus controller units 1216 and a system agent core 1210. In at least one embodiment, one or more bus controller units 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1214 to manage access to various external memory devices (not shown).

In at least one embodiment, one or more of processor cores 1202A-1202N include support for simultaneous multi-threading. In at least one embodiment, system agent core 1210 includes components for coordinating and operating cores 1202A-1202N during multi-threaded processing. In at least one embodiment, system agent core 1210 may additionally include a power control unit (PCU), which includes logic and components to regulate one or more power states of processor cores 1202A-1202N and graphics processor 1208.

In at least one embodiment, processor 1200 additionally includes graphics processor 1208 to execute graphics processing operations. In at least one embodiment, graphics processor 1208 couples with shared cache units 1206, and system agent core 1210, including one or more integrated memory controllers 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with ring interconnect 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor cores 1202A-1202N and graphics processor 1208 use embedded memory modules 1218 as a shared Last Level Cache.

In at least one embodiment, processor cores 1202A-1202N are homogenous cores executing a common instruction set architecture. In at least one embodiment, processor cores 1202A-1202N are heterogeneous in terms of instruction set architecture (ISA), where one or more of processor cores 1202A-1202N execute a common instruction set, while one or more other cores of processor cores 1202A-1202N executes a subset of a common instruction set or a different instruction set. In at least one embodiment, processor cores 1202A-1202N are heterogeneous in terms of microarchitecture, where one or more cores having a relatively higher power consumption couple with one or more power cores having a lower power consumption. In at least one embodiment, processor 1200 can be implemented on one or more chips or as a SoC integrated circuit.

Inference and/or training logic are used to perform inferencing and/or training operations associated with one or more embodiments. Details regarding inference and/or training logic are provided herein in conjunction with FIGS. 5A and/or 5B. In at least one embodiment portions or all of inference and/or training logic may be incorporated into processor 1200. For example, in at least one embodiment, training and/or inferencing techniques described herein may use one or more of ALUs embodied in graphics processor 1512, graphics core(s) 1202A-1202N, or other components in FIG. 10. Moreover, in at least one embodiment, inferencing and/or training operations described herein may be done using logic other than logic described with respect to FIG. 5A or 5B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can be used to generate synthetic data imitating failure cases in a network training process, which can help to improve performance of the network while limiting the amount of synthetic data to avoid overfitting.

### VIRTUALIZED COMPUTING PLATFORM

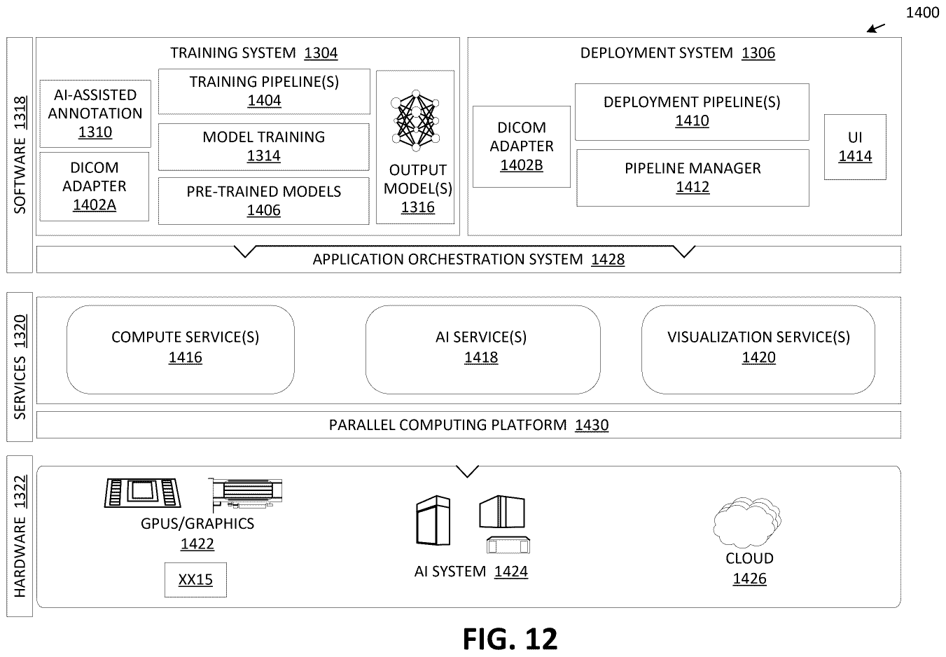

FIG. 11 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facilities 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility 1302 using data 1308 (such as imaging data) generated at facility 1302 (and stored on one or more picture archiving and communication system (PACS) servers at facility 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

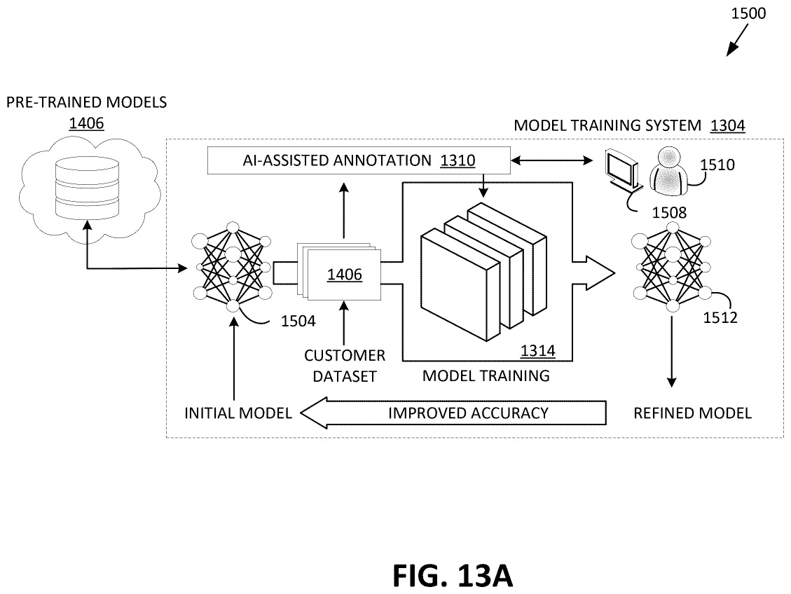

In at least one embodiment, model registry 1324 may be backed by object storage that may support versioning and object metadata. In at least one embodiment, object storage may be accessible through, for example, a cloud storage (e.g., cloud 1426 of FIG. 12) compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1404 (FIG. 12) may include a scenario where facility 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotations 1310 may then be used directly, or may be adjusted or fine-tuned using an annotation tool to generate ground truth data. In at least one embodiment, AI-assisted annotations 1310, labeled clinic data 1312, or a combination thereof may be used as ground truth data for training a machine learning model. In at least one embodiment, a trained machine learning model may be referred to as output model 1316, and may be used by deployment system 1306, as described herein.

In at least one embodiment, training pipeline 1404 (FIG. 12) may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model 1316—and may be used in deployment system 1306 to perform one or more processing tasks for one or more applications of a deployment system.

In at least one embodiment, training pipeline 1404 (FIG. 12), a scenario may include facility 1302 requiring a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotations 1310, labeled clinic data 1312, or a combination thereof—may be used as ground truth data for retraining or updating a machine learning model. In at least one embodiment, a trained machine learning model may be referred to as output model 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1400 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1400 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1400 of FIG. 12). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform 1430 (FIG. 12)). In at least one embodiment, rather than each application that shares a same functionality offered by a service 1320 being required to have a respective instance of service 1320, service 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a service 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 12 is a system diagram for an example system 1400 for generating and deploying an imaging deployment pipeline, in accordance with at least one embodiment. In at least one embodiment, system 1400 may be used to implement process 1300 of FIG. 11 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipelines 1404, similar to those described herein with respect to FIG. 11. In at least one embodiment, where one or more machine learning models are to be used in deployment pipelines 1410 by deployment system 1306, training pipelines 1404 may be used to train or retrain one or more (e.g. pre-trained) models, and/or implement one or more of pre-trained models 1406 (e.g., without a need for retraining or updating). In at least one embodiment, as a result of training pipelines 1404, output model(s) 1316 may be generated. In at least one embodiment, training pipelines 1404 may include any number of processing steps, such as but not limited to imaging data (or other input data) conversion or adaption In at least one embodiment, for different machine learning models used by deployment system 1306, different training pipelines 1404 may be used. In at least one embodiment, training pipeline 1404 similar to a first example described with respect to FIG. 11 may be used for a first machine learning model, training pipeline 1404 similar to a second example described with respect to FIG. 11 may be used for a second machine learning model, and training pipeline 1404 similar to a third example described with respect to FIG. 11 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained model(s) 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

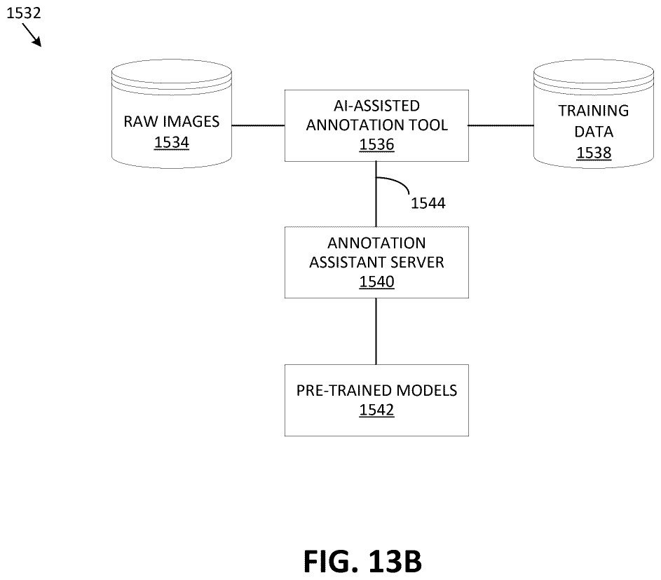

In at least one embodiment, training pipelines 1404 may include AI-assisted annotation, as described in more detail herein with respect to at least FIG. 13B. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation may be performed as part of deployment pipelines 1410; either in addition to, or in lieu of AI-assisted annotation included in training pipelines 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner.

In at least one embodiment, deployment system 1306 may execute deployment pipelines 1410. In at least one embodiment, deployment pipelines 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline 1410 depending on information desired from data generated by a device. In at least one embodiment, where detections of anomalies are desired from an MRI machine, there may be a first deployment pipeline 1410, and where image enhancement is desired from output of an MRI machine, there may be a second deployment pipeline 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipelines 1410 may be even more user friendly, provide for easier integration, and produce more accurate, efficient, and timely results.

In at least one embodiment, deployment system 1306 may include a user interface 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, user interface 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to service 1320, and/or from application or service to hardware 1322. In at least one embodiment, although illustrated as included in software 1318, this is not intended to be limiting, and in some examples (e.g., as illustrated in FIG. 10) pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute services 1416, AI services 1418, visualization services 1420, and/or other service types. In at least one embodiment, applications may call (e.g., execute) one or more of services 1320 to perform processing operations for an application. In at least one embodiment, compute services 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may enable general purpose computing on GPUs (GPGPU) (e.g., GPUs 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1418 may be leveraged to perform inferencing services for executing machine learning model(s) associated with applications (e.g., tasked with performing one or more processing tasks of an application). In at least one embodiment, AI services 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output models 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI services 1418.

In at least one embodiment, shared storage may be mounted to AI services 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT <1 min) priority while others may have lower priority (e.g., TAT <10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provided through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization services 1420 may be leveraged to generate visualizations for viewing outputs of applications and/or deployment pipeline(s) 1410. In at least one embodiment, GPUs 1422 may be leveraged by visualization services 1420 to generate visualizations. In at least one embodiment, rendering effects, such as ray-tracing, may be implemented by visualization services 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1420 may include an internal visualizer, cinematics, and/or other rendering or image processing capabilities or functionality (e.g., ray tracing, rasterization, internal optics, etc.).

In at least one embodiment, hardware 1322 may include GPUs 1422, AI system 1424, cloud 1426, and/or any other hardware used for executing training system 1304 and/or deployment system 1306. In at least one embodiment, GPUs 1422 (e.g., NVIDIA's TESLA and/or QUADRO GPUs) may include any number of GPUs that may be used for executing processing tasks of compute services 1416, AI services 1418, visualization services 1420, other services, and/or any of features or functionality of software 1318. For example, with respect to AI services 1418, GPUs 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system(s) 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may tasked with executing at least some of services 1320 of system 1400, including compute services 1416, AI services 1418, and/or visualization services 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

FIG. 13A illustrates a data flow diagram for a process 1500 to train, retrain, or update a machine learning model, in accordance with at least one embodiment. In at least one embodiment, process 1500 may be executed using, as a non-limiting example, system 1400 of FIG. 12. In at least one embodiment, process 1500 may leverage services 1320 and/or hardware 1322 of system 1400, as described herein. In at least one embodiment, refined models 1512 generated by process 1500 may be executed by deployment system 1306 for one or more containerized applications in deployment pipelines 1410.

In at least one embodiment, model training 1314 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, or deleted, and/or replaced with an updated or new output or loss layer(s). In at least one embodiment, initial model 1504 may have previously fine-tuned parameters (e.g., weights and/or biases) that remain from prior training, so training or retraining 1314 may not take as long or require as much processing as training a model from scratch. In at least one embodiment, during model training 1314, by having reset or replaced output or loss layer(s) of initial model 1504, parameters may be updated and re-tuned for a new data set based on loss calculations associated with accuracy of output or loss layer(s) at generating predictions on new, customer dataset 1506 (e.g., image data 1308 of FIG. 11).

In at least one embodiment, pre-trained models 1406 may be stored in a data store, or registry (e.g., model registry 1324 of FIG. 11). In at least one embodiment, pre-trained models 1406 may have been trained, at least in part, at one or more facilities other than a facility executing process 1500. In at least one embodiment, to protect privacy and rights of patients, subjects, or clients of different facilities, pre-trained models 1406 may have been trained, on-premise, using customer or patient data generated on-premise. In at least one embodiment, pre-trained models 1406 may be trained using cloud 1426 and/or other hardware 1322, but confidential, privacy protected patient data may not be transferred to, used by, or accessible to any components of cloud 1426 (or other off premise hardware). In at least one embodiment, where a pre-trained model 1406 is trained at using patient data from more than one facility, pre-trained model 1406 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model 1406 on-premise and/or off premise, such as in a datacenter or other cloud computing infrastructure.

In at least one embodiment, when selecting applications for use in deployment pipelines 1410, a user may also select machine learning models to be used for specific applications. In at least one embodiment, a user may not have a model for use, so a user may select a pre-trained model 1406 to use with an application. In at least one embodiment, pre-trained model 1406 may not be optimized for generating accurate results on customer dataset 1506 of a facility of a user (e.g., based on patient diversity, demographics, types of medical imaging devices used, etc.). In at least one embodiment, prior to deploying pre-trained model 1406 into deployment pipeline 1410 for use with an application(s), pre-trained model 1406 may be updated, retrained, and/or fine-tuned for use at a respective facility.

In at least one embodiment, a user may select pre-trained model 1406 that is to be updated, retrained, and/or fine-tuned, and pre-trained model 1406 may be referred to as initial model 1504 for training system 1304 within process 1500. In at least one embodiment, customer dataset 1506 (e.g., imaging data, genomics data, sequencing data, or other data types generated by devices at a facility) may be used to perform model training 1314 (which may include, without limitation, transfer learning) on initial model 1504 to generate refined model 1512. In at least one embodiment, ground truth data corresponding to customer dataset 1506 may be generated by training system 1304. In at least one embodiment, ground truth data may be generated, at least in part, by clinicians, scientists, doctors, practitioners, at a facility (e.g., as labeled clinic data 1312 of FIG. 11).

In at least one embodiment, AI-assisted annotation 1310 may be used in some examples to generate ground truth data. In at least one embodiment, AI-assisted annotation 1310 (e.g., implemented using an AI-assisted annotation SDK) may leverage machine learning models (e.g., neural networks) to generate suggested or predicted ground truth data for a customer dataset. In at least one embodiment, user 1510 may use annotation tools within a user interface (a graphical user interface (GUI)) on computing device 1508.

In at least one embodiment, user 1510 may interact with a GUI via computing device 1508 to edit or fine-tune (auto)annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training 1314 to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines 1410 at a facility for performing one or more processing tasks with respect to medical imaging data.

In at least one embodiment, refined model 1512 may be uploaded to pre-trained models 1406 in model registry 1324 to be selected by another facility. In at least one embodiment, his process may be completed at any number of facilities such that refined model 1512 may be further refined on new datasets any number of times to generate a more universal model.

FIG. 13B is an example illustration of a client-server architecture 1532 to enhance annotation tools with pre-trained annotation models, in accordance with at least one embodiment. In at least one embodiment, AI-assisted annotation tools 1536 may be instantiated based on a client-server architecture 1532. In at least one embodiment, annotation tools 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation 1310, a deep learning model, for example, may receive this data as input and return inference results of a segmented organ or abnormality. In at least one embodiment, pre-instantiated annotation tools, such as AI-Assisted Annotation Tool 1536B in FIG. 13B, may be enhanced by making API calls (e.g., API Call 1544) to a server, such as an Annotation Assistant Server 1540 that may include a set of pre-trained models 1542 stored in an annotation model registry, for example. In at least one embodiment, an annotation model registry may store pre-trained models 1542 (e.g., machine learning models, such as deep learning models) that are pre-trained to perform AI-assisted annotation on a particular organ or abnormality. These models may be further updated by using training pipelines 1404. In at least one embodiment, pre-installed annotation tools may be improved over time as new labeled clinic data 1312 is added.

Such components can be used to generate synthetic data imitating failure cases in a network training process, which can help to improve performance of the network while limiting the amount of synthetic data to avoid overfitting.

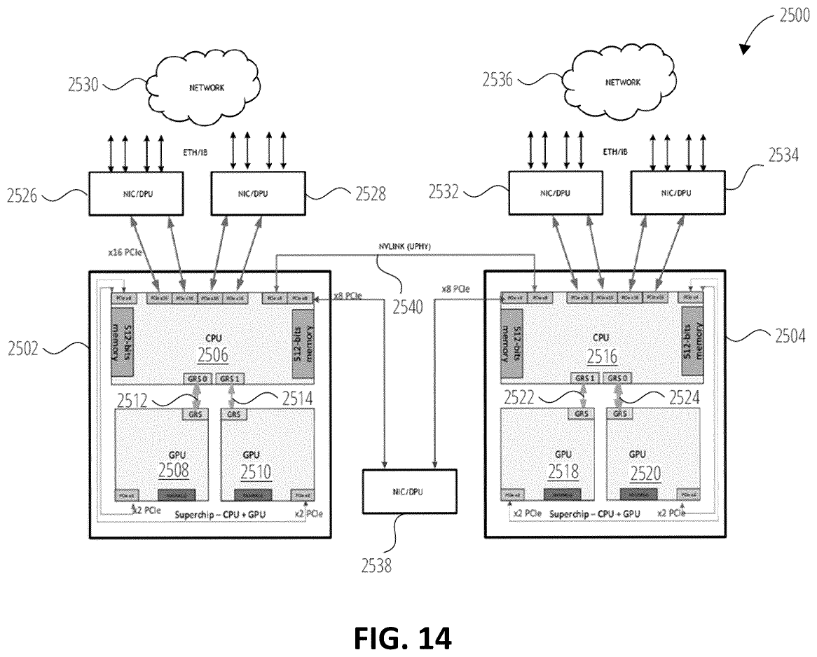

In some embodiments, calibration of cameras as described herein is performed using processors in a datacenter. FIG. 14 is a block diagram of a computing system 2500 having two processing devices coupled to each other and multiple networks according to at least one embodiment. The computing system 2500 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 2500. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 2500 highly suitable for demanding applications that require significant processing power, such as artificial intelligence (AI), machine learning (ML), and data-intensive computing, while ensuring robust connectivity and scalability across various networked environments. The integrated circuits of the computing system 2500 can include one or more CPUs and one or more GPUs. An example architecture of a multi-GPU architecture is illustrated in FIG. 14.

As illustrated in FIG. 14, the computing system 2500 includes a processing device 2502 with a multi-GPU architecture. In particular, the processing device 2502 includes a CPU 2506, a GPU 2508, and a GPU 2510. The CPU 2506 can be coupled to the GPU 2508 via an die-to-die (D2D) or chip-to-chip (C2C) interconnect 2512, such as a Ground-Referenced Signaling interconnect (GRS interconnect). The CPU 2506 can be coupled to the GPU 2510 via a D2D or C2C interconnect 2514. The CPU 2506 can also couple to the GPU 2508 and GPU 2510 via PCIe interconnects. The CPU 2506 can be coupled to one or more network interface cards (NICs) or data processing units (DPUs), which are coupled to one or more networks. For example, as illustrated in FIG. 14, the CPU 2506 is coupled to a first NIC/DPU 2526, which is coupled to a network 2530. The CPU 2506 is also coupled to a second NIC/DPU 2528, which is coupled to the network 2530. The NIC/DPU 2526 and NIC/DPU 2528 can be coupled to the network 2530 over Ethernet (ETH) or InfiniBand (IB) connections.

The computing system 2500 also includes a processing device 2504 with a multi-GPU architecture. In particular, the processing device 2504 includes a CPU 2516, a GPU 2518, and a GPU 2520. The CPU 2516 can be coupled to the GPU 2518 via an D2D or C2C interconnect 2522. The CPU 2516 can be coupled to the GPU 2520 via a D2D or C2C interconnect 2524. The CPU 2516 can also couple to the GPU 2518 and GPU 2520 via PCIe interconnects. The CPU 2516 can be coupled to one or more NICs or DPUs, which are coupled to one or more networks. For example, as illustrated in FIG. 14, the CPU 2516 is coupled to a first NIC/DPU 2532, which is coupled to a network 2536. The CPU 2516 is also coupled to a second NIC/DPU 2534, which is coupled to the network 2536. The NIC/DPU 2532 and NIC/DPU 2534 can be coupled to the network 2536 over Ethernet (ETH) or InfiniBand (IB) connections.

In at least one embodiment, the processing device 2502 and the processing device 2504 can communication with each other via a NIC/DPU 2538, such as over PCIe interconnects. The processing device 2502 and processing device 2504 can also communicate with each other over a high-bandwidth communication interconnects 2540, such as an NVLink interconnect or other high-speed interconnects.

The computing system 2500 includes various types of interconnects. Each of the interconnects includes the transceivers or receivers that include the controller 102, as described herein.

In at least one embodiment, the computing system 2500 is used for high-speed network communication and includes a processing unit (e.g., CPU 2506, GPU 2508, GPU 2508, CPU 2516, GPU 2518, GPU 2520, NIC/DPU 2526, NIC/DPU 2528, NIC/DPU 2532, NIC/DPU 2534, or NIC/DPU 2538), and a network interface coupled to the processing unit. The network interface includes a receiver circuit, a Forward Error Correction (FEC) circuit operatively coupled to the receiver circuit, and a controller operatively coupled to the receiver circuit and the FEC circuit. The controller can receive equalized error data from the receiver circuit. The controller can determine, using the equalized error data and a nominal signal power, a SNR deviation metric, the SNR deviation metric being indicative of an estimated post-FEC bit error rate (BER) of the FEC circuit. The controller can adjust, based on the SNR deviation metric, at least one of a FEC parameter of the FEC circuit or a link parameter of the receiver circuit.

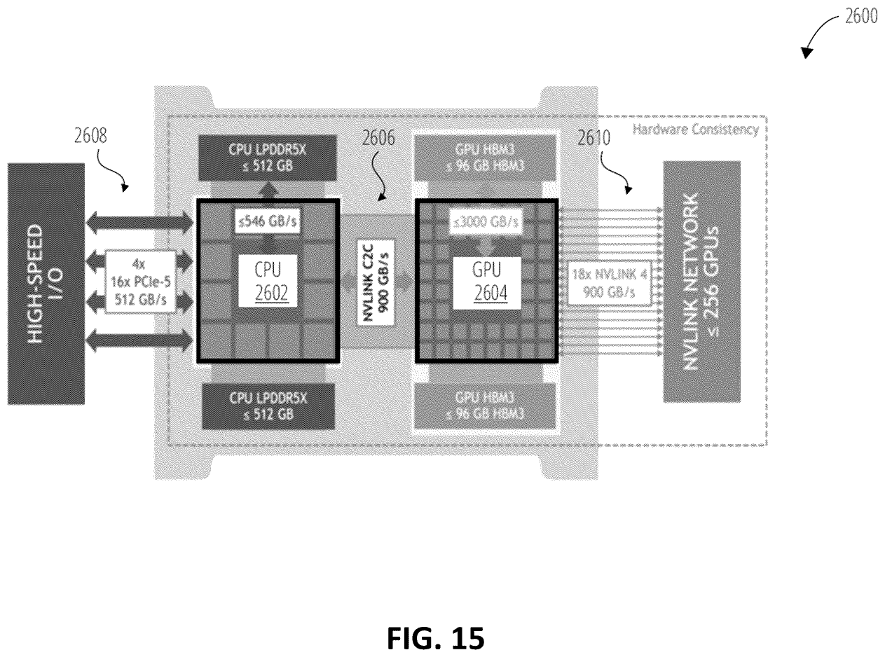

FIG. 15 is a block diagram of a computing system 2600 having a CPU 2602 and a GPU 2604 in a single integrated circuit according to at least one embodiment. The computing system 2600 can be a highly integrated design where a CPU 2602 and GPU 2604 are connected on a single integrated circuit, utilizing an NVLink C2C (Chip-to-Chip) interconnect 2606 to enable fast, low-latency communication between the two processing units. This close integration allows for efficient data transfer and parallel processing between the CPU 2602 and GPU 2604, optimizing performance for complex computational tasks. The GPU elements within the computing system 2600 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 2610. Additionally, the computing system 2600 can be designed to interface with a high-speed I/O through PCIe interconnects 2608, ensuring rapid data transfer to and from external devices, further enhancing the system's capabilities in handling data-intensive tasks and providing robust connectivity to peripheral components. It should be noted that the C2C interconnects 2606 can be considered D2D interconnects since the CPU 2602 and the GPU 2604 are located on the same integrated circuit. The integrated circuit can include CPU memory (also referred to as main memory) and GPU memory, which are accessible by the CPU 2602 and the GPU 2604, respectively, over high-speed interconnects. The computing system 2600 can bring together performance of the GPU 2604 with the versatility of the CPU 2602. The CPU 2602 can be connected with a high-bandwidth and memory coherent C2C interconnects 2606 in a single integrated circuit. The computing system 2600 can support a link switch system.

In at least one embodiment, the computing system 2600 is used for high-speed network communication and includes a processing unit (e.g., CPU 2602, GPU 2604, NVLink network), and a network interface coupled to the processing unit.

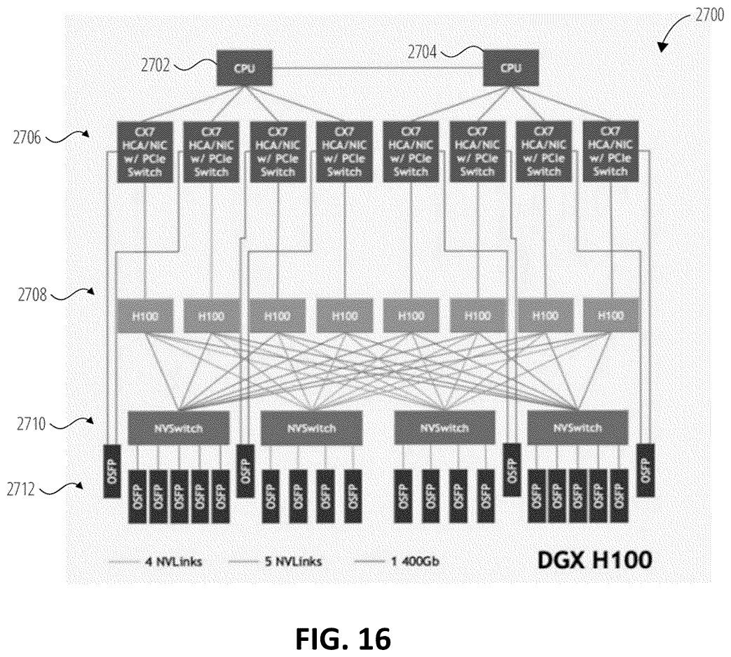

FIG. 16 is a block diagram of a computing system 2700 having tensor core GPUs 2708 according to at least one embodiment. The computing system 2700 can be a DBX H100 system, which is a high-performance computing platform designed to meet the demands of AI, ML, and deep learning (DL) workloads. The computing system 2700 can include multiple tensor core GPUs 2708 (e.g., NVIDIA H100 Tensor Core GPUs). The tensor core GPUs 2708 can each be one of the integrated circuits described above with respect to FIG. 15. The tensor core GPUs 2708 can be optimized for AI/ML/DL applications, offering exceptional performance for deep learning training, inference, and high-performance computing tasks. The tensor core GPUs 2708 within the computing system 2700 are interconnected using high-speed communication interfaces like NVLinks, enabling rapid data transfer between them, which is crucial for handling large-scale AI models and datasets with low latency. This computing system 2700 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 2708, the computing system 2700 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 2708 for their specific applications. The computing system 2700 is ideally suited for large-scale AI model training, real-time inference, scientific simulations, data analytics, and other compute-intensive tasks that require massive parallel processing power.

The tensor core GPUs 2708 can be coupled to multiple CPUs, such as CPU 2702 and CPU 2704, using switches 2706 (e.g., CX7 HCA/NIC with PCIe switch). The tensor core GPUs 2708 can be coupled to each other via switches 2710 (e.g., NVSwitches). The switches 2706 and switches 2710 can be coupled to high-speed transceiver modules 2712. The high-speed transceiver modules 2712 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 2700 remains capable of meeting increasing data demands and can be upgraded to support future advancements in network speeds, thus contributing to the system's overall performance and scalability.

In at least one embodiment, the computing system 2700 can be considered a data-network configuration with full-bandwidth intra-server NVLinks. In this example, all eight tensor core GPUs 2708 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 2708 can half-subscribe eighteen NVLinks to GPUs in other servers. Four tensor core GPUs 2708 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 2708 can independently transfer data, using Remote Direct Memory Access (RDMA) protocol, over its own dedicated switch (e.g., 400 Gb/s HCA/NIC) in a multi-rail InfiniBand/Ethernet configuration. In this example, 800 GBps of aggregate full-duplex to non-NVLink network devices.

In at least one embodiment, the computing system 2700 is used for high-speed network communication and includes a processing unit (e.g., CPU 2702, CPU 2702, switches 2706, tensor core GPUs 2708, switches 2710, high-speed transceiver modules 2712).

The computing system 2500, 2600, and 2700 may be similar to computing device 110 as described above with respect to FIG. 1

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
receiving, from an image capture device of a plurality of image capture devices of an environment, one or more images of a calibration target;
determining, for each image of the one or more images, a pose of the calibration target associated with a respective image, the pose comprising at least one of a position or an orientation of the calibration target in a local coordinate system of a local positioning system; and
calibrating the image capture device based at least on a relationship between a particular position of the calibration target in the one or more images and an associated pose of the calibration target in the local coordinate system.

2. The method of claim 1, further comprising:
determining a path for the calibration target that travels through fields of view of the plurality of image capture devices; and
moving the calibration target along the path;
wherein each image capture device of the plurality of image capture devices is calibrated based at least on the one or more images of the calibration target and one or more associated poses of the calibration target generated as the calibration target moves along the path.

3. The method of claim 2, wherein the calibration target is coupled with a robot that automatically moves the calibration target along the path.

4. The method of claim 1, wherein the image capture device captures images at a first frame rate, wherein the local positioning system captures poses of the calibration target at a second frame rate that is different from the first frame rate, and wherein determining the pose of the calibration target associated with the respective image comprises:
determining a first timestamp of the respective image; and
determining, from a plurality of poses of the calibration target, the pose having a second timestamp that is closest in time to the first timestamp.

5. The method of claim 1, wherein the image capture device captures images at a first frame rate, wherein the local positioning system captures poses of the calibration target at a second frame rate that is different from the first frame rate, and wherein determining the pose of the calibration target associated with the respective image comprises:
determining a first timestamp of the respective image;
determining, from a plurality of poses of the calibration target, that no poses have a second timestamp that is within a threshold time distance from the first timestamp;
selecting two or more poses from the plurality of poses having respective timestamps that are closest in time to the first timestamp; and
interpolating the pose at the first timestamp using the two or more selected poses.

6. The method of claim 1, wherein the calibration target comprises a visual marker detectable by the plurality of image capture devices and one or more positioning devices positioned around the visual marker that are detectable by the local positioning system.

7. The method of claim 1, wherein the relationship between the particular position of the calibration target in the one or more images and the associated pose of the calibration target is determined by:
determining the particular position of the calibration target in an image of the one or more images;
determining at least one of the position or orientation of the calibration target of a pose that is associated with the image; and
using the at least one of the position or orientation of the calibration target of the pose that is associated with the image, calculating rotation and translation vectors that form an extrinsic calibration matrix for the image capture device.

8. The method of claim 7, wherein the associated pose is a local pose in the local coordinate system of the local positioning system, the method further comprising:
converting the local pose of the calibration target to a global pose of the calibration target in a global coordinate system of the environment based on at least one of an offset or a rotation between the local coordinate system and the global coordinate system.

9. A system comprising:
a memory device; and
a processing device coupled to the memory device, wherein the processing device is to perform operations comprising:
receiving, from an image capture device of a plurality of image capture devices of an environment, one or more images of a calibration target;
determining, for each image of the one or more images, a pose of the calibration target associated with a respective image, the pose comprising at least one of a position or an orientation of the calibration target in a local coordinate system of a local positioning system; and
calibrating the image capture device based at least on a relationship between a particular position of the calibration target in the one or more images and an associated pose of the calibration target in the local coordinate system.

10. The system of claim 9, wherein the processing device is to perform operations further comprising:
determining a path for the calibration target that travels through fields of view of the plurality of image capture devices; and
moving the calibration target along the path;
wherein each image capture device of the plurality of image capture devices is calibrated based at least on the one or more images of the calibration target and one or more associated poses of the calibration target generated as the calibration target moves along the path.

11. The system of claim 10, wherein the calibration target is coupled with a robot that automatically moves the calibration target along the path.

12. The system of claim 9, wherein the image capture device captures images at a first frame rate, wherein the local positioning system captures poses of the calibration target at a second frame rate that is different from the first frame rate, and wherein determining the pose of the calibration target associated with the image comprises:
determining a first timestamp of the respective image; and
determining, from a plurality of poses of the calibration target, the pose having a second timestamp that is closest in time to the first timestamp.

13. The system of claim 9, wherein the image capture device captures images at a first frame rate, wherein the local positioning system captures poses of the calibration target at a second frame rate that is different from the first frame rate, and wherein determining the pose of the calibration target associated with the image comprises:
determining a first timestamp of the respective image;
determining, from a plurality of poses of the calibration target, that no poses have a second timestamp that is within a threshold time distance from the first timestamp;
selecting two or more poses from the plurality of poses having respective timestamps that are closest in time to the first timestamp; and
interpolating the pose at the first timestamp using the two or more selected poses.

14. The system of claim 9, wherein the calibration target comprises a visual marker detectable by the plurality of image capture devices and one or more positioning devices positioned around the visual marker that are detectable by the local positioning system.

15. The system of claim 9, wherein the relationship between the particular position of the calibration target in the one or more images and the associated pose of the calibration target is determined by:
determining the particular position of the calibration target in an image of the one or more images;
determining at least one of the position or orientation of the calibration target of a pose that is associated with the image; and
using the at least one of the position or rotation pf the calibration target of the pose that is associated with the image, calculating rotation and translation vectors that form an extrinsic calibration matrix for the image capture device.

16. The system of claim 9, wherein the associated pose is a local pose in the local coordinate system of the local positioning system, and wherein the processing device is to perform operations further comprising:
converting the local pose of the calibration target to a global pose of the calibration target in a global coordinate system of the environment based on at least one of an offset or a rotation between the local coordinate system and the global coordinate system.

17. A non-transitory computer-readable storage medium comprising instructions that, when executed by a processing device, cause the processing device to perform operations comprising:
receiving, from an image capture device of a plurality of image capture devices of an environment, one or more images of a calibration target;
determining, for each image of the one or more images, a pose of the calibration target associated with a respective image, the pose comprising at least one of a position or an orientation of the calibration target in a local coordinate system of a local positioning system; and
calibrating the image capture device based at least on a relationship between a particular position of the calibration target in the one or more images and an associated pose of the calibration target in the local coordinate system.

18. The non-transitory computer-readable storage medium of claim 17, wherein the processing device is to perform operations further comprising:
determining a path for the calibration target that travels through fields of view of the plurality of image capture devices; and
moving the calibration target along the path;
wherein each image capture device of the plurality of image capture devices is calibrated based at least on the one or more images of the calibration target and one or more associated poses of the calibration target generated as the calibration target moves along the path.

19. The non-transitory computer-readable storage medium of claim 18, wherein the calibration target is coupled with a robot that automatically moves the calibration target along the path.

20. The non-transitory computer-readable storage medium of claim 17, wherein the image capture device captures images at a first frame rate, wherein the local positioning system captures poses of the calibration target at a second frame rate that is different from the first frame rate, and wherein determining the pose of the calibration target associated with the respective image comprises:
determining a first timestamp of the respective image; and
determining, from a plurality of poses of the calibration target, the pose having a second timestamp that is closest in time to the first timestamp.
